(19) United States
(12) Patent Application Publication
(10) Pub. No.: US 2023/0083351 A1
(43) Pub. Date: Mar. 16, 2023

(54) SYSTEM AND METHOD FOR PROVIDING PATENT TITLE INSURANCE WITH CENTRALIZED AND DISTRIBUTED DATA ARCHITECTURES

(71) Applicants: ERICH LAWSON SPANGENBERG, PARIS (FR); DANIEL LAWRENCE BORK, EAST KINGSTON, NH (US); PASCAL ASSELOT, PARIS (FR)

(72) Inventors: ERICH LAWSON SPANGENBERG, PARIS (FR); DANIEL LAWRENCE BORK, EAST KINGSTON, NH (US); PASCAL ASSELOT, PARIS (FR)

(21) Appl. No.: 17/849,670

(22) Filed: Jun. 26, 2022

Related U.S. Application Data
(63) Continuation of application No. 16/849,754, filed on Apr. 15, 2020, now abandoned.
(60) Provisional application No. 62/834,705, filed on Apr. 16, 2019.

(51) Int. Cl. G06Q 40/08; G06Q 20/36; G06Q 50/18

(52) U.S. Cl. CPC G06Q 40/08; G06Q 20/3678; G06Q 50/184

(57) ABSTRACT

The present invention discloses a method by which a secure ledger network is deployed to provide assurance related to title of IP assets. Specifically, the invention seeks to improve the risk associated with IP based transactions and reduce the time related to researching color of title related to the same.

### PRIORITY CLAIMS

This application is a continuation of U.S. patent application Ser. No. 16/849,754, filed Apr. 15, 2020, which claims the benefit of U.S. Provisional Patent Application Ser. No. 62/834,705 filed on Apr. 16, 2019, which is incorporated herein.

### FIELD OF THE INVENTION

This invention deals with securing a guarantee against a possible eventuality of invalidity of title for patent applications and registrations.

### BACKGROUND OF THE INVENTION

Many people are familiar with the concept of color of title in real estate transactions. However, color of title also applies in intellectual property and patent law which governs the ownership of information or ideas. In this context, color of title is a phrase that means having the appearance of title to a patent, but in actuality, there is either no title or a vital defect in the title. Therefore, if one has color of title, then the other (actual) patent holder has a “cloud on title” since his title has a defect or “cloud” on it.

Confidence in the ownership and the title of an asset is a prerequisite for a transaction to take place. Buyers do not want to purchase patents with title issues. Sellers would rather not lose a transaction over title issues and would like to avoid any claims against them for title defects. In some jurisdictions, failure to properly record title has other negative consequences for patent owners. Lenders and investors require assurance that the patent owner has title and that any prior liens are removed. Title representations by sellers that are conditioned by phrases like, “To seller's knowledge, . . . ” are not necessary and depress prices. A simple example: If you were shopping online for a large screen television and as you were completing your order a message came on the screen and said: “We are pretty sure we own this TV and when you pay us we are pretty sure you will own it,” would you pay full price for the TV? We would not either.

Unfortunately, chain-of-title issues plague the patent asset class. Ownership records at patent offices are rarely, if ever, updated and may include clerical and other errors. This issue is further complicated because there is no accurate, central, public repository of worldwide patent ownership. Correcting chain-of-title issues in a patent portfolio slows down patent transactions and, in certain cases, can deter transactions. Market participants need a trusted partner who can leverage its resources to identify and quickly and cost-effectively correct title issues early in the process.

Inasmuch as intangibles are gaining increasing importance in both domestic and international transactions, as well as in litigation, it is becoming increasingly important to provide parties to such transactions or who may be affected by litigation with more reliable, accurate, and cost-effective information through the due diligence process. Such information may include, for example, verification of the chain of title of the asset, identification of the encumbrances on the asset, the validity and enforceability of the asset, as well as past and pending litigation which involves or otherwise impacts the asset. As the certainty among purchasers, inves-tors, insurers and financers in the transferability and market-ability of such assets increases, the market value of the asset should also increase, and should lead to more litigation being averted, transactions being completed, and investments being made.

Traditionally, assessing and assuring the risks in the purchase of an asset often involves extensive and costly due diligence. This is because there is little to no way to know of any specific records related to an assignment or license. Such licenses and assignments can be recorded through several jurisdictions and through several countries. As a result, when patent related transactions occur, due diligence becomes extremely important.

The due diligence related to determining color of title of a patent application is costly, since it may require manual and semi-automated searching of various and disparate records, data-bases and other sources. This problem is difficult enough to solve when the property is tangible, such as in the cases of real estate and personal property. However, the problem is further compounded when the asset is related to intangible property, such as patents, trademarks, and copyrights.

The present invention discloses the first publicly available, worldwide, patent and patent publications ownership registry system answers the question of patent ownership. The Global Patent Registry is a blockchain-based system that applies distributed trust and artificial intelligence (AI) techniques to provide reliable title information available to anyone who needs this information. IPwe leverages its deep knowledge of chain-of-title issues, AI and the Global Patent Registry to provide title confirmation services to all market participants including patent owners, acquirers, licensees, counsel, brokers and investors.

Intermediaries, like brokers and counsel, face the same issues as their clients when it comes to chain-of-title issues in patent transactions. The tedious task of reviewing a patent portfolio's chains-of-title is not a valuable use of time for intermediaries who could instead be applying their resources toward delivering higher-value services to their clients. The present invention replaces the intermediary and thus saves money and frees up valuable resources for providing its specialized services.

Instead of the seller making a representation that the seller owns the patents, the patent title insurance affiliate offers a very inexpensive per patent policy that pays out if it turns out the Seller did not have title to the patents. The Seller, Buyer, Licensor or Licensee could purchase this policy. It is inexpensive and easy to obtain, and it reduces risk and should increase the price of the patents being sold. The insurance covers the purchase price of the patents.

An important development with respect to the present invention relates to the use of blockchain technology. Blockchain technology (sometimes simply referred to as a blockchain) was developed and has been used in certain digital currency implementations. An example implementation and corresponding blockchain techniques are described in a 2008 article by Satoshi Nakamoto, called “Bitcoin: A Peer-to-Peer Electronic Cash System,” the entire contents of which are hereby incorporated by reference. With that being said, in certain embodiments discussed herein, the blockchain may be privately hosted (e.g., where all member nodes are run and provided by the same entity or a controlled group of entities). In certain example embodiments, the blockchain may be a distributed blockchain, such as the one provided by the bitcoin network. Thus, the term blockchain as used herein is not confined to the so-called blockchain that is only used for the bitcoin cryptographic currency.

The blockchain is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new blockchain transaction is then submitted to the blockchain. Once on the blockchain multiple such transactions are bundled into a block and the block is linked to a prior block in the “blockchain.” Computer nodes of the distributed system then maintain the blockchain and validate each new block (along with the transactions contained in the corresponding block). The techniques described herein make use of blockchain technology to address one or more problems with the conventional database systems

Blockchain technology holds great promise for a range of industries and business cases, including the patent asset class. That is because a Blockchain can be viewed as a type of shared database, the contents of which are verified and agreed upon by a network or independent actors. For a new piece of data (such as the owner of a newly issued patent) to be added to the Blockchain, the independent verifiers must come to consensus on its validity. Because each new set of transactions (a “block”) is cryptographically linked to the previous block, it is extraordinarily difficult to change data stored in a Blockchain and any such change would be readily detectable. Thus, blockchains are widely considered to be immutable and thus can serve as a record of proof of ownership.

When transacting in a Blockchain platform, each user makes use of a public address (needed for other actors in the network to send a transaction to that user), and a cryptographically paired “private key.” Private keys are used to sign transactions digitally, a form authentication to ensure that a given user has genuinely generated a transaction.

Blockchain is a relatively new technology. The first “real world” implementations of Blockchain, Bitcoin, envisioned by Satoshi Nakamoto launched in 2009. The Ethereum Blockchain was released in 2015. In addition to the distributed ledger capability of the Bitcoin Blockchain, the Ethereum Blockchain allows so-called “smart contracts,” which are programs stored in the Ethereum Blockchain that can act autonomously to execute sophisticated transactions.1

Blockchain data transfer is currently considered one the most secure technologies for digital asset transfer due to its distributed nature and use of sophisticated cryptography. Smart contracts, therefore, offer a potential solution for the management of patent transactions via the introduction of a universal, distributed ledger that does not require trust in a single third party. “Ethereum Whitepaper,” http://github.com/ethereum/wiki/wiki/white-paper, 2016

The Bitcoin blockchain is limited to sets of simple information and scripts such as transaction details, and conditioning a transaction on a minimum number of signatories. It was therefore argued that for a virtual currency to truly revolutionize trade it must also provide built-in means for facilitating complex contracts and deals with the currency.

Project Ethereum builds upon Bitcoin. Not only does it allow decentralized data storage in its blockchain, Ethereum also allows storing program code on its blockchain and running it concurrently by any number of network members. By predicating release of funds upon verifiable occurrences, Ethereum enables smart contract functionality.

Basically, a network member uploads a computer program written in one of several permitted languages to the blockchain. The member may then condition the release of an amount of ETH (the currency underlying Ethereum) upon reaching the end of this program. Various network members thereafter run the program concurrently and reach a consensus on the resulted output.

The scripting languages in Ethereum or the IBM Hyperledger are Turing complete as they can implement any logic rules and initiate any calculations available.

This feature allows any member to issue and trade with a custom virtual currency upon the Ethereum network. For the sake of clarity, a custom virtual currency issued and based upon another virtual currency is referred to as a Token. A Token may have various uses. While a certain Token will represent money, another Token will represent club member points or frequent flyer points. Tokens may be traded for ETH or for any other commodities and Tokens via the Ethereum or the IBM Hyperledger network.

Before Ethereum or the IBM Hyperledger, a person was required to launch a new blockchain utilizing custom user clients and mining algorithm, in order to issue a custom decentralized virtual currency. The emergence of the Ethereum or the IBM Hyperledger network allows easy issuance of Tokens with minimal setup.

It should be mentioned that after Ethereum, several other virtual currency networks implementing smart contracts were established. Prominent examples include the IBM Hyperledger, Lisk and RootStock.

### SUMMARY OF THE INVENTION

The present system relates to a method of reducing risk related to the color of title in patent intellectual property assets. Such assets may include, patents, trademarks, copyrights and other forms of intangible property. The system and method of the present invention provides assurance to those wanting to transact with these assets regarding the title of the asset.

The system and method of the instant invention may comprise a network, the network consisting of a series of nodes, each node capable of communicating with at least one other node in the series of nodes. The network configured to recursively record all transactions that occur over the network on a secure digital ledger. The transactions encoded using a method such as a checksum.

The network is capable of issuing a smart contract, or a series of computer executable code, with preprogrammed rules related to the title of at least one intellectual property asset, which when executed will record a transfer, license, or other transaction related to said asset on the secure ledger. This is considered a cryptographically secure network. The network will allow a user to claim title to an intellectual property asset, and another user to purchase insurance on the title of that intellectual property asset.

The network will be accessible over the web, and may further employ real-time or reactive computing systems and methodologies to enable due diligence to be conducted Such that results generated by the system and method may be returned to the user during a single interactive computing session.

### BRIEF DESCRIPTION OF THE DRAWINGS

FIG. 1 is a diagram of the patent title confirmation process using the present invention.

FIG. 2 is a diagram of the smart securities process for patent assets using the present invention.

FIG. 3 is a flow diagram of the patent insurance process of the present invention.

FIG. 4 is an illustration of one aspect of the present invention.

### DETAILED DESCRIPTION OF THE PREFERRED EMBODIMENT

The proposed invention seeks to distributed blockchain allow for the simple verification and deployment of assurance related to color of title if intellectual property assets. Through the use a secure ledger blockchain network a system to assure title of intellectual property assets is envisioned.

This decentralized network will require at least one server, a processor, and at least one networking interface (“Network” or “IPwe Platform” or “IPwe”). Such a Network will allow the connection of user devices through the Internet. The Network itself will consist of at least one server, which will host a webpage, that when executed, will allow users to access a portal and be identified cryptographically using a private key and public key. The web portal or other network connected device will provide a platform to connect a patent owner with other stakeholders int eh patent process.

In one embodiment of the present invention, the decentralized network is a blockchain network. Blockchain technology (sometimes simply referred to as a blockchain) was developed and has been used in certain digital currency implementations. An example implementation and corresponding blockchain techniques are described in a 2008 article by Satoshi Nakamoto, called “Bitcoin: A Peer-to-Peer Electronic Cash System,” the entire contents of which are hereby incorporated by reference. With that being said, in certain embodiments discussed herein, the blockchain may be privately hosted (e.g., where all member nodes are run and provided by the same entity or a controlled group of entities). In certain example embodiments, the blockchain may be a distributed blockchain, such as the one provided by the bitcoin network. Thus, the term blockchain as used herein is not confined to the so-called blockchain that is only used for the bitcoin cryptographic currency.

The blockchain is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new blockchain transaction is then submitted to the blockchain. Once on the blockchain multiple such transactions are bundled into a block and the block is linked to a prior block in the “blockchain.” Computer nodes of the distributed system then maintain the blockchain and validate each new block (along with the transactions contained in the corresponding block). The techniques described herein make use of blockchain technology to address one or more problems with the conventional database systems to provide a pooled resource for Patent owners and other stake holders.

A computer, network, or blockchain, may deploy a smart contract. A smart contract is computer code that implements transactions of a contract. The computer code may be executed in a secure platform (e.g., an Ethereum platform, IBM Hyperledger platform) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes initializing the smart contract and its state. The state of a smart contract is stored persistently in the blockchain (e.g., via a Merkle tree). When a transaction is recorded against a smart contract, a message is sent to the smart contract and the computer code of the smart contract executes to implement the transaction (e.g., debit a certain amount from the balance of an account, transfer the ownership of a patent). The computer processes the code and ensures that all the terms of the contract are complied with before the transaction is recorded in the blockchain. For example, a smart contract may request an exchange of one type of cryptocurrency token to another. The computer executes code to determine the exchange rate and transfers the correct amount of tokens to and from the correct accounts.

The blockchain network may include multiple computers, networks, links, and databases. Miners may manage the blockchain, whereas the managing may include, for example, validating a smart contract and/or transaction according to the smart contract, updating the blockchain with a validated smart contract and update the blockchain with a transaction that is executed according to the smart contract, determine that a suggested smart contract is invalid, determine that a transaction is not according to a smart contract, and the like.

In some embodiments, a smart contract may be accompanied by a digital certificate, or a digital signature which contains information regarding the source of the transaction. The computer, network, or blockchain will validate this information and determine the authenticity of the source of the transaction prior to deploying the smart contract.

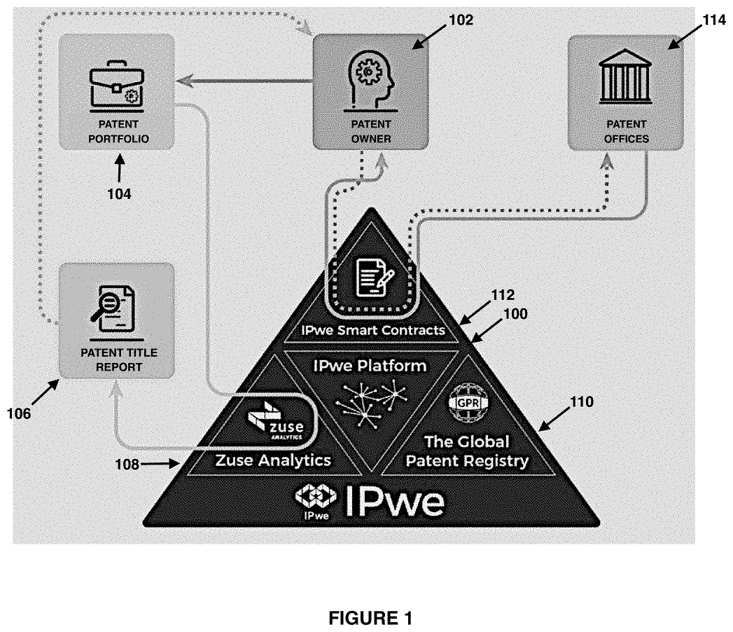

FIG. 1 is a diagram of the patent title confirmation process using the present invention. In accordance with the preferred embodiment of the present invention 100, the patent owner 102 identifies patents included in the patent owner's portfolio 104 (entire portfolio or segment transacting), and electronically submits to the analytics embodiment 108 and selects the patent ownership report 106. The analytics embodiment 108 compares ownership records at various patent offices and the global patent registry 110, and using AI analytics, issues a patent title report 106 indicating any patent ownership title discrepancies identified. The patent owner 102 then electronically selects any patent records it wishes to correct. The smart contracts embodiment 112 identifies the required patent office forms and procedures to correct any title defects. The required forms are provided to the patent owner 102 for completion, review, execution and filing with the appropriate patent office 114. The present invention 100 then updates the global patent registry 110.

The smart contract may determine the rules for evaluating a token price and an initial status of the token (such as the reserve of the token) and any other rules that should be applied during a transaction.

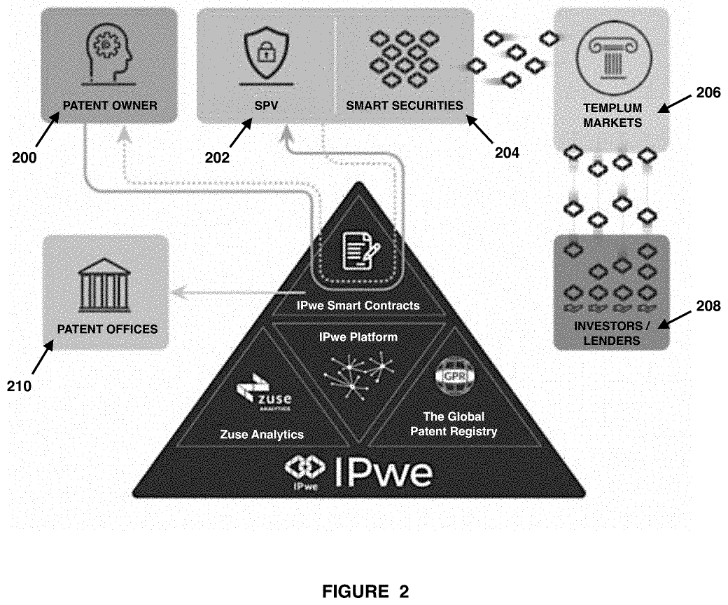

FIG. 2 is a diagram of the smart securities process for patent assets using the present invention. A patent owner 200 can establish an SPV 202 for smart securities 204 related to patent assets. Templum Markets 206 can organize the securities 204. Investor lenders 208 can purchase insurance on title at the time of purchase. Patent Offices 210 can be used to verify the color of title.

The platform itself can construct a smart contract in real time based on inputs from an inventor or patent holder. In one embodiment, the inventor submits the patent application, and the network uses an analysis engine to generate a report regarding the likelihood of patentability based on several criteria, including patentable nature of the invention, the status of prior art, and the novelty of the inventive step. The platform further provides a user to express interest in insurance, and provides a rate and insurance premium price using FIAT currency and virtual currency. The user can select the options that seem most beneficial to the user at that time.

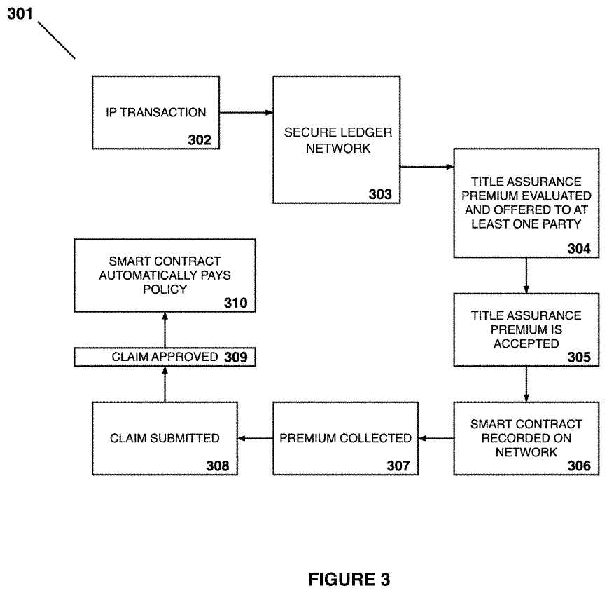

FIG. 3 is a flow diagram of the patent insurance process of the present invention. In accordance with the preferred embodiment of the present invention, a transaction 302 is recorded on the secure ledger network 303. Title assurance premium is evaluated and offered to at least one party to the transaction 304, the party accepts the premium 305 and smart contract is recorded on the network 306. The premium is collected automatically based on the rules of the smart contract 307. A user may choose to submit a claim 308 based on color of title, and if the claim is approved 309, the smart contract automatically pays out the premium 310.

One issue with the current intellectual property ecosystem is that it provides insurance for limited reasons. In one embodiment, the current invention provides customizable insurance tailored for patents, including title insurance. Said title insurance will be offered to users of the platform, and will record title and execute transactions related to intellectual property assets on the blockchain network.

In one embodiment of the present invention, a licensee seeking to acquire a license for a patent listed on the platform will be offered assurance in exchange for some monetary collateral on the title. The assurance will include a report of the known risks associated with the chain of title related to a particular intellectual property asset.

In one embodiment, the platform may record title of an asset. Under such an embodiment, the risk assessment of the title may be based on the length of time that an intellectual property asset is recorded and the number of transactions under which it is recorded for secure title.

In another embodiment, a title report is generated by an assurance engine. The assurance engine seeks information on the chain of title of an intellectual property asset through publicly available databases. Said assurance engine passes the data to a risk assessment engine. The risk assessment engine generates a risk assessment related to the intellectual property asset based on available information as to the original filer of the asset, and the chain of title available showing the current assignee.

In another embodiment, a smart contract is executed and defines the rules of the assurance related the intellectual property asset. Upon upload of a judgment showing that title was not clear, the smart contract may automatically transfer a policy amount to the injured party as defined in the rules.

In another embodiment, a smart contract containing the rules related to collect an amount of payment related to an assurance policy is executed on the blockchain. Said smart contract further contains rules related to color of title, which when occur, automatically pay a policy amount to the purchaser.

Typically, patent management insurance can be hard to quantify due to the lack of knowledge regarding future decisions. In one embodiment, the Zuse Analysis data is used to determine the likelihood that a patent or portion of a patent is likely to survive patent validity challenge based on risk to title. The analysis may be further based on historical information and the likelihood that the owner or applicant has overcome challenges to title successfully is considered when determining a value for the insurance policy.

In another embodiment, the platform can determine the eligibility for insurance and determine fees based solely on specific criterion such as patentability, prior art, obviousness, and other qualities.

In one embodiment, the network provides an insurance holder the ability to file a claim, to monitor the status of a patent claim, and to collect the appropriate recovery based on the reasons for rejection of title.

In another embodiment, the platform can offer different insurance rates, policy limits, and policy payouts based on the status of a rejection, namely if the patent is invalidated completely or partially based on title. Future offerings can be adjusted based on the same.

In one embodiment, the platform can provide the option of allowing payment of fees through alternative fee arrangements, instead of how many current insurance providers simply charge monthly or annual membership fees. The alternative fee arrangements could include paying a success fee based on if the patent is invalidated.

In one embodiment, the platform can provide patent applicants to offer their invention for review to a connected community. Members of the public may be invited to submit prior comments on title prior to a purchase or transaction.

In another embodiment, the platform may record ownership information, identification information, and provide a detailed analysis of the likelihood that a patent will withstand the various attacks to a potential investor.

In another embodiment, the crowdfunding options can further include a syndicate title related to patent applications. Analysis of the likelihood of patentability or the chances that a patent will withstand a challenge to title based on historical data, inventor data, and crowd commentary.

In one embodiment, the data analysis engine can further communicate with the decentralized network platform and increase or decrease the cost of the insurance policy premium or the insurance policy limit based on a variety of factors, including the number of matching key terms prior art, the amount of prior art, the category of the prior art, the litigious nature of prior art owners, the profitability of the patent, and the status of the use of the item.

In another embodiment, the assurance engine searches the blockchain network of patents for any similar patents and determines the policy limit and policy premium based on a rating regarding the likelihood of success in determining color of title.

In another embodiment, the assurance engine can further determine a rating for the likelihood of facing a challenge to the patent registration. The assurance engine can control the policy limit and policy rate premium offered based on a variety of factors including the litigious nature of prior art holders, the historical success of prior art in similar fields and differences in the inventive step between the existing application and the prior art.

In another embodiment, the platform can further provide assurance of title in the form of monetary compensation for copyright applications, trademark applications, all other legal areas, and any non-legal areas.

In one embodiment, the present invention contains a method of transactions wherein all fees, payments, policy limits, purchases, and services are transacted using virtual currency, or cryptocurrency. The Network can further reward various stakeholders for participation within the network using the same cryptocurrency tokens. Each token can be traded or transacted using various systems and converted to FIAT currency. Such a system is applicable as a blockchain network.

One issue with patent mitigation insurance is that it can be slow to provide payments to claimants. In one embodiment of the present invention, a smart contract is generated at the outset of obtaining insurance. The smart contract contains a set of rules that are executed so long as the patent owner retains control of the patent and pays the premium. That code can be configured to automatically release the policy limits of an insurance policy at the occurrence of a specific event, such as patent invalidity, patent application rejection, or patent cancellation. The policy can be provided in FIAT or virtual currency, and will automatically transfer upon execution of the requisite conditions.

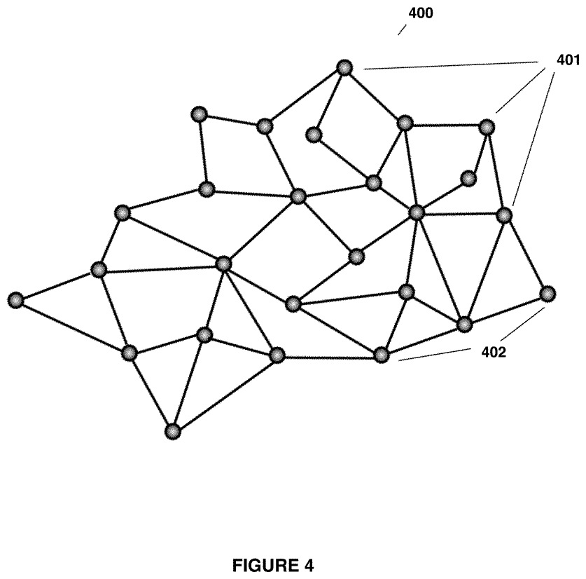

FIG. 4 depicts one aspect of the present invention. Specifically, the illustration shows the interconnection of each node 401 in a distributed decentralized network 400. In accordance with the preferred embodiment of the present invention, each node 401 in the distributed network 400 is directly connected to at least two other nodes 402. This allows each node 401 to transact with at least one other node 401 in the network.

A block chain or blockchain is a distributed database that maintains a list of data records, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies such as used in bitcoin. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger.

The blockchain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. In some embodiments, the block chain system disclosed, SS the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, that meets other criteria.

In one embodiment, the Network is made up of a plurality of nodes, each node connected to another node in the plurality of nodes, having the ability to pass data to each of the connected plurality of nodes. At least one node of the plurality of nodes is connected to an existing blockchain. Using this existing blockchain the, decentralized transactions can take place.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

As another example, a computer-readable medium comprising computer executable instructions for causing a client device to perform a method for device discovery and communication is provided, the method comprising broadcasting a request to identify a registry server, receiving a response from a registry server, and sending client update information to the registry server. The registry server is part of a registry group of the distributed hierarchical registry, where the registry group comprises a plurality of registry servers. The registry server updates other registry servers of the registry group with the client update information using, at least in part, a quorum consensus protocol.

In some embodiments, the system is further able to conserve network and computing resources by securely storing information associated with user data, preventing potential malicious activity involving such information, conserving bandwidth, memory, and computation resources.

A digital wallet is software and hardware (or specifically designed hardware) that allows an individual to make electronic commerce transactions that use, a blockchain. The digital wallet is a data structure that can include a private key (e.g., that is only known to the holder of the wallet) and a series of identifiers (sometimes called wallet identifiers, blockchain identifier, or walletIDs herein) that have been generated based on the private key. These identifiers are used to allow other users to “send” transactions, which are recorded on the blockchain, to that identifier. For example, the above novation process creates two blockchain transactions for a trade between Publisher (“Party A”) and the distributed decentralized network administrator (“Party B”). A first blockchain transaction may be from the wallet of party A to the wallet of the Party B. A second blockchain transaction may be from the wallet of the Party B to a wallet of party A. These transactions may be separately generated and submitted to the blockchain. Alternatively, the blockchain may only have one “wallet” that is being used for interacting with the blockchain. Other types of implementations may also be possible (e.g., where different parties, or their respective computer systems, use their own keys for a central blockchain). In certain embodiments, the wallets may be centrally managed by the distributed decentralized network computer system that the parties associated with the trade. However, the transactions recorded to the blockchain may still be signed by or otherwise associated with the individual wallets of the patent stakeholders.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

The present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of”

What is claimed is:

1. A method for providing IP Asset Title Insurance, the method comprising:
evaluating a premium rate of an insurance policy related to title of an intellectual property asset transaction occurring on a secure ledger distributed network;
offering at least one party to the transaction an insurance on title for the intellectual property asset;
upon acceptance of the insurance by the at least one party to the transaction, recording a smart contract on the secure ledger distributed network, which when executed collects a policy premium from the at least one party to the transaction;
determining the status of an insurance claim; and
distributing a policy amount as included in the smart contract.
